(19) United States
(12) Patent Application Publication
(10) Pub. No.: US 2015/0308806 A1
(43) Pub. Date: Oct. 29, 2015

(54) SCORING TOOL

(71) Applicants: Greg DeSilva, East Providence, RI (US); Colton Gouveia, Bristol, RI (US)

(72) Inventors: Greg DeSilva, East Providence, RI (US); Colton Gouveia, Bristol, RI (US)

(21) Appl. No.: 14/262,857

(22) Filed: Apr. 28, 2014

(51) Int. Cl. G01B 3/10

(52) U.S. Cl. CPC G01B 3/1056; G01B 2003/1089

(57) ABSTRACT

A scoring tool is disclosed that includes a body with a retractable tape therein and a tang on one end of the tape, the tang having a blade-receiving structure thereon configured and arranged to receive a blade of a utility knife therethrough.

### BACKGROUND OF THE INVENTION

1. Field of the Invention

The present patent document relates generally to cutting and hanging tools used in interior home improvement and construction projects, such as to score drywall, and more particularly to a scoring tool.

2. Background of the Related Art

Drywall (also known as plasterboard, wallboard, gypsum board, sheetrock, or gyprock) is a panel made of gypsum plaster pressed between two thick sheets of paper. It is used to make interior walls and ceilings. Drywall construction became prevalent as a speedier alternative to traditional lath and plaster.

As an alternative to a week-long plaster application, an entire house can be drywalled in one or two days by two experienced drywallers, and drywall is easy enough to use that it can be installed by many amateur home carpenters. In large-scale commercial construction, the work of installing and finishing drywall is often split between the drywall mechanics, or hangers, who install the wallboard, and the tapers and mudmen, or float crew, who finish the joints and cover the nailheads with drywall compound.

Drywall is cut to size, using a large T-square, by scoring the paper on the front side (usually white) with a utility knife, breaking the sheet along the cut, and cutting the paper backing. Small features such as holes for outlets and light switches are usually cut using a keyhole saw or a small high-speed bit in a rotary tool. Drywall is then fixed to the wall structure with nails, glue, or more commonly in recent years, the now-ubiquitous drywall screws.

Using a T-square to cut the drywall to size is accurate, but slow. Alternatively, experienced workmen will cut the drywall free-hand, using a tape measure in conjunction with a utility knife. By holding the tape measure in one hand, extended to the desired length and holding the utility knife and tang of the tape measure in the other hand, the experienced workman can score the drywall. The disadvantage with this technique is that it takes practice and, if the workman is not careful, can ruin a sheet of drywall if the cut meanders or the utility knife slips. The workman may even cut themselves too.

Other materials may be cut using this technique as well, such as ceiling tiles, roof insulation, vapor barrier, rubber tiles, and the like. Also, more durable materials, such as plywood, sheet metal, wood planks, and the like, may be scored to show a mark for subsequent cutting with a hand or powered saw, instead of using a pen or pencil.

Therefore, there is a need for a method and tool of quickly scoring a workpiece that is accurate and safe, but overcomes the disadvantages of using a T-square or other marking and scoring techniques that are slower.

### SUMMARY OF THE INVENTION

The scoring tool described herein solves the problems of the prior art by providing a scoring tool that includes a body with a retractable tape therein and a tang on one end of the tape, the tang having a blade-receiving structure thereon, which further defines a slot to receive a blade of a utility knife therethrough. Because the tang has a blade-receiving structure thereon, the drywaller may easily use the tool with two hands, one holding the body of the tool and the other holding the utility knife with the blade inserted into the blade-receiving structure.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the scoring tool;

FIG. 2 is a close-up, top view of the tang (or hook) of the scoring tool;

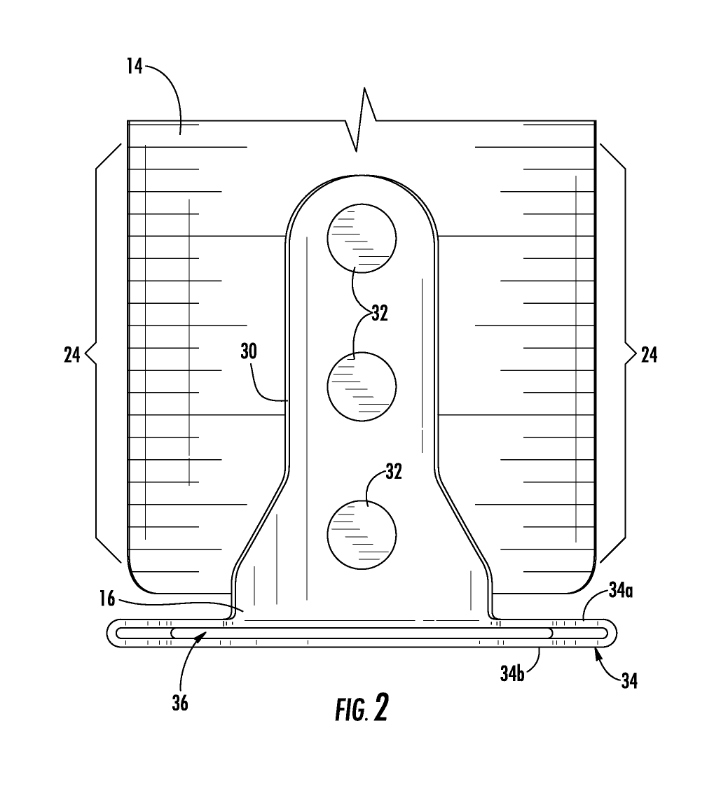

FIG. 3 is a close-up perspective view of the tang of the scoring tool;

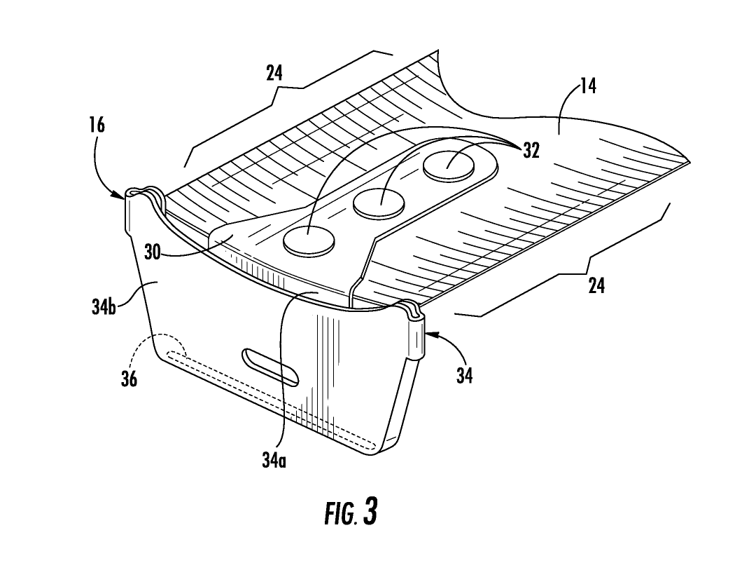

FIG. 4 is a close-up, perspective view of the tang of the scoring tool with a knife inserted into the slot on the tang; and

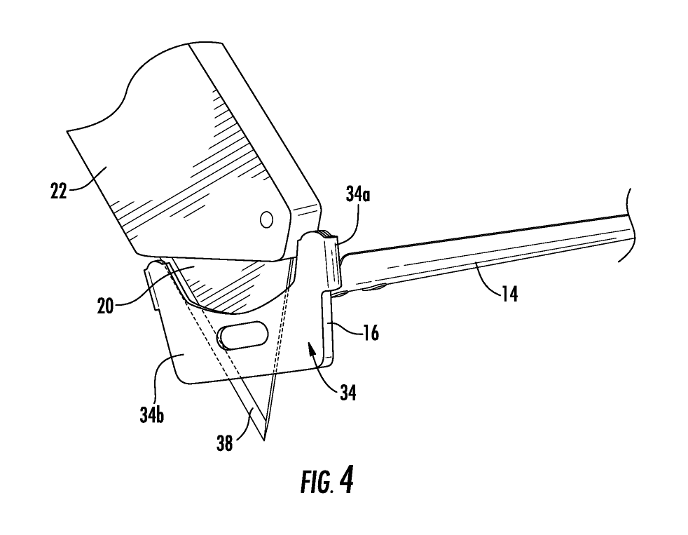

FIG. 5 is an illustration showing use of the scoring tool on a workpiece.

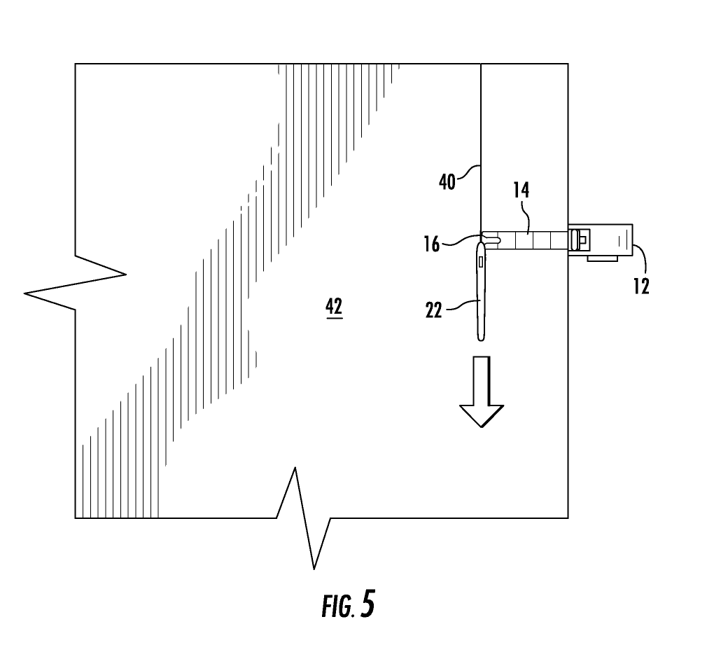

### DESCRIPTION OF THE PREFERRED EMBODIMENT

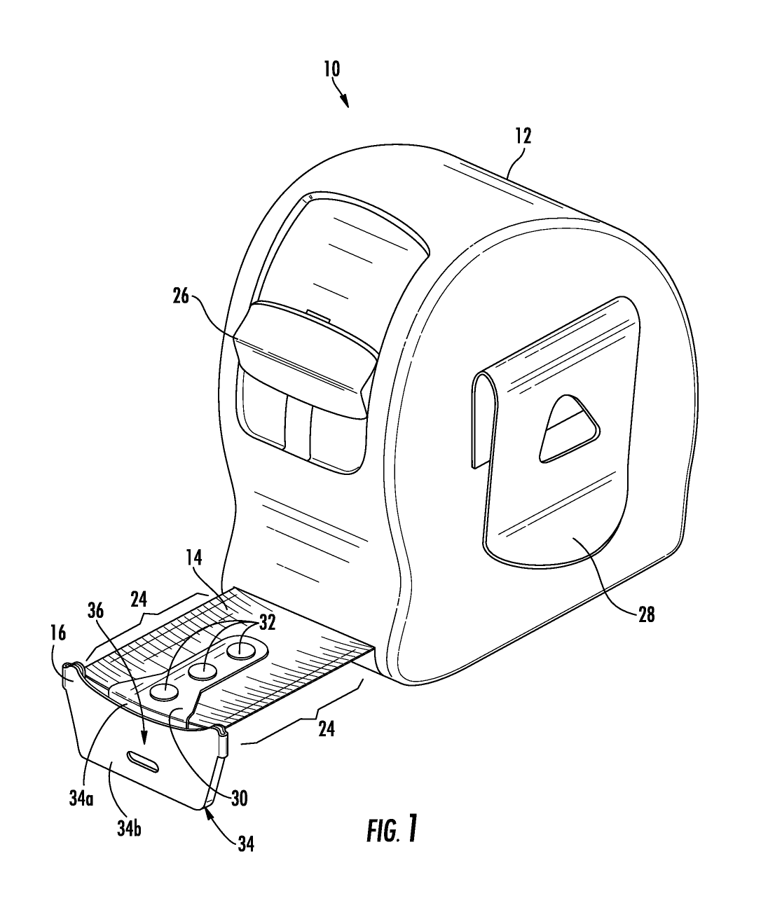

Referring now to FIG. 1, the scoring tool is shown generally at 10. The scoring tool 10 includes a tape measure body 12 with a self-retracting measuring tape 14 therein and more preferably a tape blade. An end of the tape blade 14 includes a tang 16 (or hook), permitting the tape 14 to drawn out of the body 12. The tape 14 includes a uniquely slotted tang 16 with a blade-receiving structure thereon 18, which permits a blade 20 of a knife 22 to be inserted therethrough. The tape 14 is preferably ruled with metric or English measurements 24 to allow person to quickly take a measurement of an object or distance.

As is known in the art, a spring motor (not shown) inside the body 12 is tensioned as the tape 14 is drawn from a spool inside the body 12 and retracts the tape 14 back into the body 12 when the tang 16 is released. The body 12 may include a slide lock 26 that engages the tape 14 and lock it in place, thereby preventing the tape 14 from being drawn or retracted while the slide lock 26 is engaged. The body 12 may further include a belt clip 28.

The tang 16 of the tape 14 has a first section 30 secured to the end of the tape 14, typically by rivets 32, which may further allow the tang 16 to slide along the tape 14 to assess both inside and outside measurements accurately. The tang 16 includes a blade-receiving structure 34 which comprises a second section 34a formed perpendicular to the first section 30. A third section 34b connected to the second section 34a, forming a slot 36 between the second section 34a and third section 34b sized and dimension to receive a utility knife blade therethrough such that the tip 38 of the blade 20 projects through the slot 36 and beneath the blade-receiving structure 34.

In use, the tape 14 is extended to the desired size of the cut. The slide lock 26 may or may not be engaged as desired by the workman to lock the tape 14 in its extended position. The workman next places the blade 20 of the utility knife 22 into the slot 36 of the blade-receiving structure 34 tang 16, ensuring it extends therethrough. With one hand on the measuring tape body 12 and the other holding the utility knife 22, the workman scores 40 the workpiece 42 in a continuous downward stroke the length of the desired cut. Because the blade 20 is in the slot 36 of the blade-receiving structure 34 tang 16, the utility knife 22 cannot slip or wander during the cut. Once the score 40 is complete the workman can release the tape 14 and finish making the cut on the score 40 of the workpiece 42.

Therefore, it can be seen that the present invention provides a unique solution to the problem of scoring workpiece in a straight line.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

1. A scoring tool, comprising:
a body with a retractable tape therein; and
a tang consisting of a first section secured on one end of the tape, a second section extending perpendicular from the first section and the tape, and a third section directly connected to the second section, the second section and third section spaced laterally apart and parallel to each other defining a blade-receiving slot therebetween, the slot configured and arranged to receive the blade of the utility knife therethrough whereby the blade is held perpendicular to the tape.

2. The tool of claim 1, further comprising a belt-clip on the body.

3. The tool of claim 1, further comprising a slide-lock on the body configured and arranged to lock the tape in a desired position.

4. The tool of claim 1, wherein the tape is self-retractable.

5. The tool of claim 1, wherein the tape is ruled.

6. The tool of claim 5, wherein the tape is ruled with English measurements.

7. The tool of claim 5, wherein the tape is ruled with metric measurements.

8. The tool of claim 1, wherein the tape is a tape blade.

9-12. (canceled)

13. A tape measure comprising a body with a retractable tape therein, and a tang on the end of the retractable tape with an integrated slot directly on the end of the tang configured to receive a blade of a utility knife perpendicular to the retractable tape.

14. The tool of claim 13, wherein the tape is self-retractable.

15. The tool of claim 13, wherein the tape is a tape blade.

16. A tape measure having a body with a retractable tape therein and a tang on an end of the tape forming a hook, wherein improvement comprises a section directly connected to the hook forming a slot on the end of the tang, the slot configured to hold a blade of a utility knife perpendicular to the retractable tape whereby the section does not interfere with the ability to measure with the tape measure.

17. The tool of claim 16, wherein the tape is self-retractable.

18. The tool of claim 16, wherein the tape is a tape blade.
